(19) United States
(12) Patent Application Publication
(10) Pub. No.: US 2004/0264483 A1
(43) Pub. Date: Dec. 30, 2004

(54) Communication system and method providing IP facilities to a stimuli terminal

(75) Inventors: Raymond Gass, Bolsenheim (FR); Francois Pinier, Strasbourg (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/849,131

(22) Filed: May 20, 2004

(30) Foreign Application Priority Data
Jun. 27, 2003 (EP) 03 291 588.6

(51) Int. Cl. H04L 12/28

(52) U.S. Cl. 370/401

(57) ABSTRACT

The present invention concerns a communication system comprising a media gateway controller and at least one stimuli telecommunication terminal connected to it and acting as a media gateway, wherein said terminal is remotely controlled by said controller, wherein a gateway function able to support an Internet Transfer Protocol is provided within or associated to said controller.

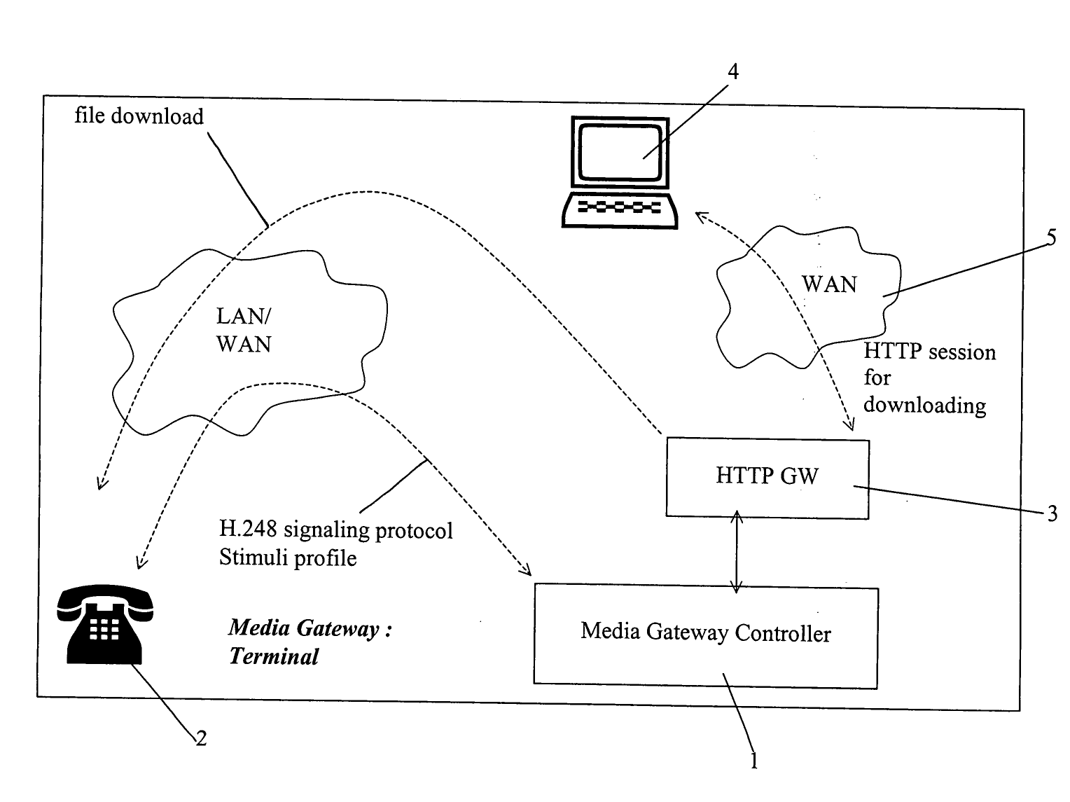

### TECHNICAL FIELD

The present invention is related to the field of the telecommunications, in particular the communications established from a telecommunication terminal and over a gateway controller. The invention is based on a priority application EP 03 291 588.6 which is hereby incorporated by reference.

### BACKGROUND OF THE INVENTION

The present invention concerns more specifically a communication system, a media gateway controller and a method for establishing a communication, allowing a stimuli telecommunication terminal to access Internet facilities.

It is known that the ITU-T H.248/IETF Megaco communication protocol, amongst other profiles, describes a stimulus protocol between a master unit (media gateway controller) and a slave unit (media gateway) which is remotely controlled by the master unit.

This general concept covers mainly two types of media gateways: IP PBXs (Internet Protocol Private Branch Exchanges) and IP terminal sets.

The current definition of H.248 protocol takes into account several packages for remotely handling various applications like tone generator and detector, DTMF generator and detector, analog line supervisor, facsimile transmission, keyboard, keypad, screen display, SCTP session, ATM transport, and so on.

When considering the implications at terminal level, it can be noticed that full stimuli terminals are completely dumb, and fully remotely controlled (in the above case by the media gateway controller) for any elementary operation (off hook, set up loudpseaker, etc.) One must admit that this solution has at least two major advantages:

it is economic (low cost terminal: intelligence in the system shared by several terminals)

easy evolution (scenarios may change in the system without any impact on the terminal).

But this proposal is only valid as long as the time interval, at the considered terminal, between event (for example off hook) and action (for example tone) remains short enough.

However, with LAN based systems, involving VoIP technology, latency between media gateway controller and terminal might be too long, in particular in a WAN configuration, and generate potential QoS (Quality of Service) problems.

Moreover, the current release of H.248 protocol does not support the handling of a HTTP session and therefore completely inhibits capabilities and features such as download of files (e.g. sound file, compressed digital photography, video stream file) or any applet inside a H.248 terminal. For example, the download of a ringing melody in a H.248 terminal from a Web server through a simple browser using HTTP communication protocol (e.g. Netscape or Internet Explorer) is considered as being a very pleasant and common feature, as such feature is already available for cellular phones.

It is a major aim of the invention to overcome the aforementioned limitations.

### SUMMARY OF THE INVENTION

Therefore, the present invention concerns a communication system comprising a media gateway controller and at least one stimuli telecommunication terminal connected to it and acting as a media gateway, wherein said terminal is remotely controlled by said controller, characterised in that a gateway function able to support an Internet Transfer Protocol is provided within or associated to said controller.

### BRIEF DESCRIPTION OF THE DRAWINGS

The present invention will be better understood thanks to the following description of additional features and advantages, and will now be described in more details, by way of example, in relation to a non limitative embodiment shown on the enclosed drawing, wherein the sole FIGURE is a schematical representation of a communication system of the invention.

### DETAILED DESCRIPTION OF PREFERRED EMBODIMENTS

As shown, the communication system comprises a media gateway controller 1 and at least one stimuli telecommunication terminal 2 connected to it and acting as a media gateway, wherein said terminal 2 is remotely controlled by said controller 1.

According to the main feature of the invention, a gateway function 3 able to support an Internet Transfer Protocol is provided within or associated to said controller 1.

Preferably, but not restrictively, said Internet Transfer Protocol comprises Hypertext Transfer Protocol (HTTP) and the communication link between the controller 1 and the or each of the terminal(s) 2 is based on the H.248 protocol.

As it is noticeable on the enclosed drawing, the gateway function 3 is able to handle HTTP sessions based on trigger signals from the terminal 2, display signals towards the terminal 2 and file downloading.

Advantageously, the trigger signals are in the form of H.248 stimuli and the display signals are in the form of extensible markup language (XML).

The present invention also encompasses a media gateway controller 1 connected to at least one stimuli terminal, said controller 1 realising a remote control of said terminal(s) by means of a stimulus protocol.

According to the invention, said controller 1 comprises or is associated with a gateway function 3, having the ability to support an Internet Transfer Protocol.

Preferably of course, said controller 1 will be part of a communication system as described before.

Furthermore, another subject matter of the present invention consists in a telecommunication terminal based on a stimuli telecommunication terminal, and comprising means for connection to a media gateway controller, characterised in that it also comprises means for connection to an Internet Transfer Protocol based gateway 3.

Preferably, said telecommunication terminal 2 will be part of a communication system as described before and connectable to an aforementioned media gateway controller 1.

Thus, in comparison to full stimuli telecommunication terminals, the invention proposes a solution corresponding to a considered evolution of the latters, but which still shows the two advantages set forth in the introducing part, without the mentioned limitation.

Instead of completely passive terminals, the invention proposes an intermediate solution, whereby some simple decisions can be taken at terminal level to avoid having to wait for event/action messages to be exchanged between the terminal 2 and the media gateway controller 1.

In particular, the invention can provide that the off hook/tone sequence is handled directly by the terminal 2 itself and that, with tones generated inside the terminals means in the form of a HTTP gateway offers the possibility to download melodies for ringing/tones.

Finally, the present invention is also concerned with a method for establishing a communication between a stimuli telecommunication terminal 2 connected to and controlled by a media gateway controller 1, on the one hand, and a distant terminal or server 4, on the other hand, over at least a wide area network 5.

Said method is characterised in that it comprises the steps of performing a remote operation directly generated by or acting on said terminal 2 by means of a gateway function 3 able to support an Internet Transfer Protocol, said gateway function 3 being provided within or associated to said controller 1.

Said method may be advantageously carried out on a communication system as mentioned herein previously and shown on the enclosed drawing.

The present invention is, of course, not limited to the preferred embodiment described and represented herein, changes can be made or equivalents used without departing from the scope of the invention.

1. Communication system comprising a media gateway controller and at least one stimuli telecommunication terminal connected to it and acting as a media gateway, wherein said terminal is remotely controlled by said controller, wherein a gateway function able to support an Internet Transfer Protocol is provided within or associated to said controller.

2. Communication system according to claim 1, wherein said Internet Transfer Protocol comprises Hypertext Transfer Protocol.

3. Communication system according to claim 1, wherein the communication link between the controller and the or each of the terminal(s) is based on the H.248 protocol.

4. Communication system according to claim 2, wherein the gateway function is able to handle HTTP sessions based on trigger signals from the terminal, display signals towards the terminal and file downloading.

5. Communication system according to claim 4, wherein the trigger signals are in the form of H.248 stimuli and the display signals are in the form of extensible markup language.

6. Media gateway controller connected to at least one stimuli terminal, said controller realising a remote control of said terminal(s) by means of a stimulus protocol, wherein said controller comprises or is associated with a gateway function, having the ability to support an Internet Transfer Protocol.

7. Media gateway controller connected to at least one stimuli terminal, said controller realising a remote control of said terminal(s) by means of a stimulus protocol, wherein said controller comprises or is associated with a gateway function, having the ability to support an Internet Transfer Protocol, wherein it is part of a system according to claim 1.

8. Telecommunication terminal based on a stimuli telecommunication terminal, and comprising means for connection to a media gateway controller, wherein it also comprises means for connection to an Internet Transfer Protocol based gateway.

9. Telecommunication terminal based on a stimuli telecommunication terminal, and comprising means for connection to a media gateway controller, wherein it also comprises means for connection to an Internet Transfer Protocol based gateway,
wherein it is part of a communication system comprising a media gateway controller and at least one stimuli telecommunication terminal connected to it and acting as a media gateway, wherein said terminal is remotely controlled by said controller, wherein a gateway function able to support an Internet Transfer Protocol is provided within or associated to said controller and connectable to a media gateway controller according to claim 6.

10. Method for establishing a communication between a stimuli telecommunication terminal connected to and controlled by a media gateway controller, on the one hand, and a distant terminal or server, on the other hand, over at least a wide are network, method wherein it comprises the steps of performing a remote operation directly generated by or acting on said terminal by means of a gateway function able to support an Internet Transfer Protocol, said gateway function being provided within or associated to said controller.

11. Method for establishing a communication between a stimuli telecommunication terminal connected to and controlled by a media gateway controller, on the one hand, and a distant terminal or server, on the other hand, over at least a wide are network, method wherein it comprises the steps of performing a remote operation directly generated by or acting on said terminal by means of a gateway function able to support an Internet Transfer Protocol said gateway function being provided within or associated to said controller,
wherein it is carried out on a system according to claim 1.
